(19) United States
(12) Patent Application Publication
(10) Pub. No.: US 2006/0026216 A1
(43) Pub. Date: Feb. 2, 2006

(54) Server-assited communication among clients

(75) Inventor: Kenneth Mark Maxham, Redwood City, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Mirra, Inc.

(21) Appl. No.: 11/177,660

(22) Filed: Jul. 8, 2005

Related U.S. Application Data
(60) Provisional application No. 60/592,632, filed on Jul. 30, 2004.
(60) Provisional application No. 60/592,671, filed on Jul. 30, 2004.
(60) Provisional application No. 60/592,633, filed on Jul. 30, 2004.

(51) Int. Cl. G06F 17/30

(52) U.S. Cl. 707/201

(57) ABSTRACT

A communication system may include a network, a server, and one or more clients. The server may verify that a communication among two or more of the clients should occur. The server may provide linking data to the two or more peers. The two or more client may use the linking data to send and/or receive a communication. The communication system may include a communication linking module that may receive a communication from one client and may send the communication to at least one other client. The communication may comprise content distribution, content synchronization, or another type of communication.

### CROSS-REFERENCE TO RELATED APPLICATIONS

This applications claims priority to and the benefit of U.S. Provisional Patent Application No. 60/592,632, filed Jul. 30, 2004 entitled SERVER-ASSISTED COMMUNICATION AMONG CLIENTS, which is hereby incorporated by reference herein in its entirety. This application is also related to U.S. Provisional Patent Application No. 60/592,671, filed Jul. 30, 2004 and entitled CONTENT DISTRIBUTION AND SYNCHRONIZATION and U.S. Provisional Application No. 60/592,633, filed Jul. 30, 2004 and entitled AUTHENTICATING CLIENT-TO-CLIENT COMMUNICATION, which are hereby incorporated by reference herein in its entirety.

### BACKGROUND OF THE INVENTION

1. Field of the Invention

The present invention relates generally to communication. More specifically, the present invention relates to systems and methods for content distribution, content synchronization, and other suitable activities.

2. Related Technology

Computer and data communications networks continue to proliferate. Such networks—including wide area networks (“WANs”) and local area networks (“LANs”)—help increase productivity through sharing resources and transferring (or otherwise processing) voice and data. For example, in many systems, a file server may be connected to a network. Once connected to the network, a plurality of computers may access the file server to store and/or revise data files on the file server.

In some systems, computers may remotely access a file server, allowing a variety of persons in a variety of remote locations to collaborate on the same file. However, unreliable networks, unreliable hardware, and limited bandwidth can limit the effective collaboration in these systems. Further, because many businesses and individuals use incompatible networks, accessing the file server can often be difficult.

Accordingly, to collaborate, many persons choose to manually distribute original copies and any subsequent revisions using electronic mail (“e-mail”). Of course, this practice requires a person to diligently remember to circulate versions regularly to ensure that the other collaborators may see the latest revisions. Also, this requires a user to remember to address the e-mail to each recipient. This can be frustrating and time consuming for users that frequently share different files among different groups. Further, in some instances, attaching files to an e-mail message may result in truncated and/or corrupted files. Lastly, sending files via e-mail can waste a significant amount of storage space on an e-mail server—requiring users and/or system administrators to delete messages more often.

In some systems, computers may access a file server, allowing a person manually store a redundant copy of a data file on the file server. While helping to avoid some loss of data, this practice requires a person to diligently remember to store backups regularly to minimize data loss. Further, even with systems that backup data on scheduled intervals, the data loss between intervals can be significant.

### BRIEF SUMMARY OF EMBODIMENTS OF THE INVENTION

A need therefore exists for systems and methods that reduce some of the above-described disadvantages and problems, reduce all of the above-described disadvantages and problems, and/or reduce other disadvantages and problems.

In one embodiment, clients such as appliances and/or computing devices communicate using a network environment. An appliance or a computing device may include a content management module configured to distribute and/or to synchronize data for backup purposes, for collaboration purposes, or for any other suitable purposes.

In one embodiment, a server is provided that may include a communication management module configured to establish communication among two or more clients (such as, appliances, computing devices, web browsers, and the like). For example, the communication management module may verify that a communication should occur between clients. The communication management module may provide linking data to facilitate communication between the clients. The clients may then use the linking data to send and/or receive content.

In one embodiment, a first client uses at least a portion of the linking data to send a first request to send content to a communication linking module, and a second client uses at least a portion of the linking data to send a second request to receive content to the communication linking module. In response to the first request, the communication linking module may receive content from the first client and, in response to the second request, may send the content to the second client. If desired, the first client, the second client, or both may send their requests using a client-initiated protocol or another suitable protocol or any other suitable protocol.

In one embodiment, the linking data may comprise a resource identifier. A first client may use the resource identifier to request to send content to the communication linking module. A second client may use the resource identifier to request to receive the content from the communication linking module. The communication linking module may be configured to compare all or a portion of a resource identifier from the first client's request to send content with all or a portion of a resource identifier from the second client's request to receive content. At least partially in response to this comparison, the communication linking module may determine that content should be received from first client and sent to the second client. The communication linking module may be configured to buffer some or all of the content it receives from the first client until sending that content to the second client.

For purposes of summarizing, some aspects, advantages, and novel features have been described. Of course, it is to be understood that not necessarily all such aspects, advantages, or features will be embodied in any particular embodiment of the invention. Further, embodiments of the invention may comprise aspects, advantages, or features other than those that have been described. Some aspects, advantages, or features of embodiments of the invention may become more fully apparent from the following description and appended claims or may be learned by the practice of embodiments of the invention as set forth in this disclosure.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. Certain embodiments of the invention will be described and explained with additional specificity and detail through the use of the accompanying drawings in which:

FIG. 1A is a block diagram illustrating an exemplary embodiment of a networking system;

FIG. 1B is a block diagram illustrating an embodiment of the networking system shown in FIG. 1A;

FIG. 2A is a block diagram illustrating the use of the Hypertext Transfer Protocol;

FIG. 2B is a block diagram illustrating the use of a firewall;

FIG. 3 is a block diagram of an embodiment of the networking system shown in FIG. 1A in which two or more clients may communicate;

FIG. 4A is a flowchart illustrating an exemplary method that may be performed using the networking system shown in FIG. 3;

FIG. 4B is a flowchart illustrating an exemplary method that may be performed using the networking system shown in FIG. 3;

FIG. 4C is a flowchart illustrating an exemplary method that may be performed using the networking system shown in FIG. 3;

FIG. 4D is a flowchart illustrating an exemplary method that may be performed using the networking system shown in FIG. 3;

FIG. 4E is a flowchart illustrating an exemplary method that may be performed using the networking system shown in FIG. 3;

FIG. 5A is a flowchart illustrating an exemplary method that may be performed using the networking system shown in FIG. 3;

FIG. 5B is a flowchart illustrating an exemplary method that may be performed using the networking system shown in FIG. 3;

FIG. 5C illustrates a resource identifier according to an embodiment of the invention; and

FIG. 5D illustrates a resource identifier according to an embodiment of the invention.

### DETAILED DESCRIPTION OF THE PREFERRED EMBODIMENTS

Exemplary Networking System

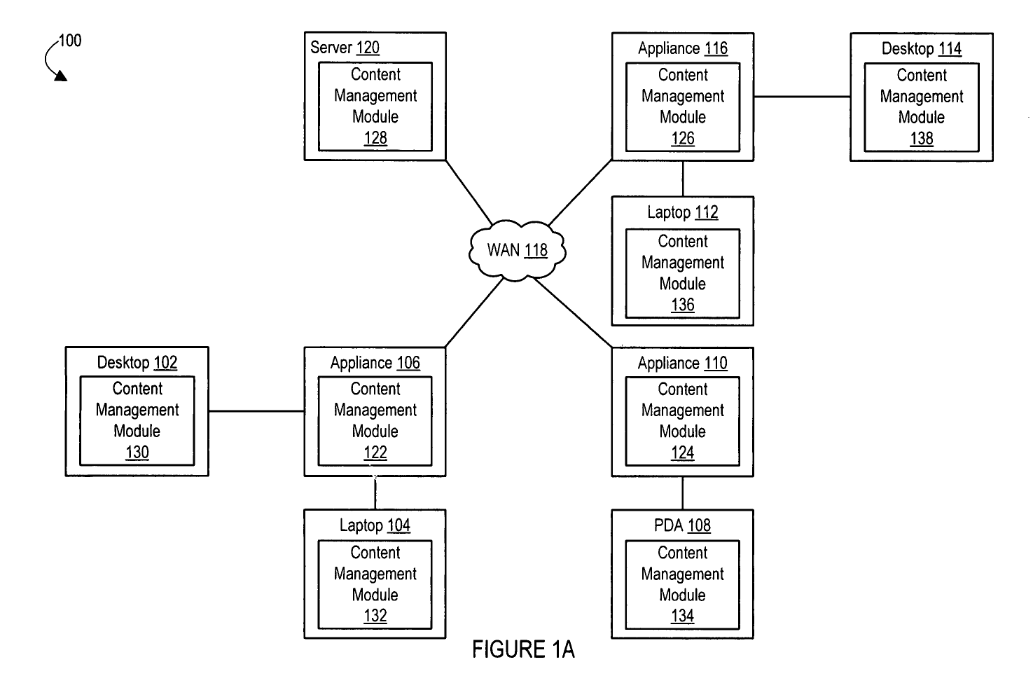

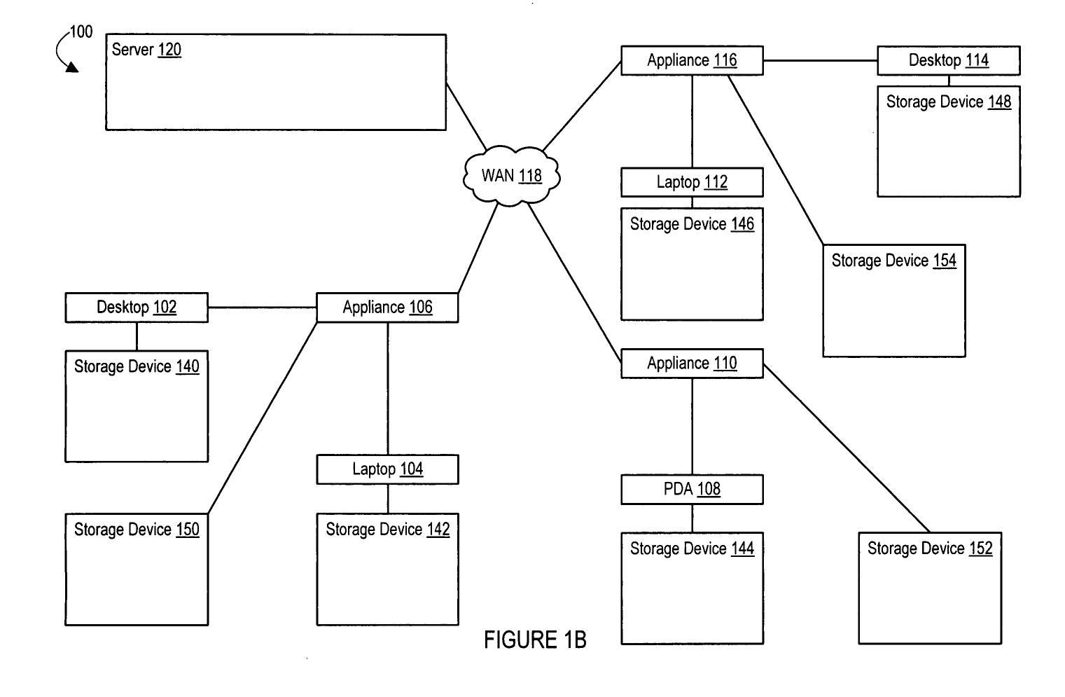

FIG. 1A is a block diagram illustrating an exemplary embodiment of a networking system 100 for implementing embodiments of the present invention. The networking system 100 may include one or more computing devices. As used herein, “computing device” is a broad term and is used in its ordinary meaning and may include, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

As shown in FIG. 1A, the networking system 100 may include one or more appliances 106, 116, and 110, which are examples of computing devices. Each appliance 106, 110, and 116 may be associated with one or more computing devices. For example, a desktop computer 102 and a laptop computer 104 may be connected to the appliance 106; a PDA 108 may be connected to the appliance 110; and a laptop computer 112 and a desktop computer 114 may be connected to the appliance 116. Generally, each appliance can be associated with multiple computing devices and each computing device can be associated with multiple appliances.

As further illustrated in FIG. 1A, an appliance and any associated computing devices may be interconnected to form a network, such as a local area network. For example, the desktop computer 102, the laptop computer 104, and the appliance 106 may comprise a local area network; the PDA 108 and the appliance 110 may comprise a local area network; and the laptop computer 112, the desktop computer 114, and the appliance 116 may comprise a local area network. An appliance and any associated computing devices may be interconnected using any other suitable network including, but not limited to, a local area network, a WAN, the Internet, any other network, any other connection, or any combination thereof.

As shown in FIG. 1A, the networking environment 100 may include one or more networks, such as a network 118. The network 118 may comprise of a plurality of linked local area networks. Although illustrated as a wide-area network (WAN), the network 118 may comprise a local area network, a WAN, the Internet, any other network, any other connection, or any combination thereof. The networking environment 100 does not require the network 118. As shown in FIG. 1A, appliances, computing devices, servers, or a combination thereof may advantageously communicate via the network 118.

In one embodiment, the network 118 may comprise a geographically widespread network. For example, an appliance (such as, the appliance 106) may be geographically remote from another appliance (such as, the appliance 116). An appliance (such as, the appliance 106) and/or one or more of the appliance's associated computing devices (such as, the desktop 102 and the laptop 104) may be positioned in any relative location with respect to another appliance (such as, the appliance 116) and/or one or more of its associated computing devices (such as, the laptop 112 and the desktop 114). An appliance and/or the appliance's associated computing devices may be positioned in any number of other suitable locations with respect to another appliance and/or one or more of its associated computing devices.

As shown in FIG. 1A, the networking environment 100 may include a server 120, which may comprise one or more servers that may include one or more hardware modules, one or more software modules, or both.

The networking environment 100 may include a content management system. The content management system may advantageously provide communication features, content creation features, content transfer features, content backup features, content sharing features, content distribution features, content synchronization features, any other suitable features, or any suitable combination thereof. As used herein, “content” is a broad term and is used in its ordinary meaning and includes, but is not limited to, software, documents, data, information, electronic files, any electronic materials that may be useful or desirable to backup, any electronic materials that may be useful or desirable to distribute in a network environment, any electronic materials that may be useful or desirable to synchronize in a network environment, any electronic materials that may be useful or desirable to make accessible from a remote location, any other electronic materials that may be useful or desirable to employ embodiments of the invention, and the like. The content management system may comprise a distributed system. The content management system may comprise one or more modules, which may comprise hardware components, software components, or both. The content management system may be implement using one or more computing devices, one or more appliances, one or more servers, or a combination thereof.

For example, the appliance 106 may include a content management module 122; the appliance 110 may include a content management module 124; and the appliance 116 may include a content management module 126. Similarly, a computing device, a server, or both may include module(s) related to content management as described herein. For example, the server 120 may include a content management module 128; the desktop 102 may include a content management module 130; the laptop 104 may include a content management module 132; the PDA 108 may include a content management module 134; the laptop 112 may include a content management module 136; and the desktop 114 may include a content management module 138.

FIG. 1B is a block diagram illustrating an embodiment of the networking environment 100 in which appliances, computing devices, or both may include one or more associated storage devices or have access to storage devices (hard drives, Random access memory, flash memory, and the like) either locally or remotely. For example, the desktop 102 may include a storage device 140; the laptop 104 may include a storage device 142; the PDA 108 may include a storage device 144; the laptop 112 may include a storage device 146; and the desktop 114 may include a storage device 148. Similarly, the appliance 106 may include a storage device 150; the appliance 110 may include a storage device 152; and the appliance 116 may include a storage device 154.

If desired, the networking system 100 and/or any component thereof may (but need not) include some or all of the features of the network environments and/or any component or the like.

Client Requests

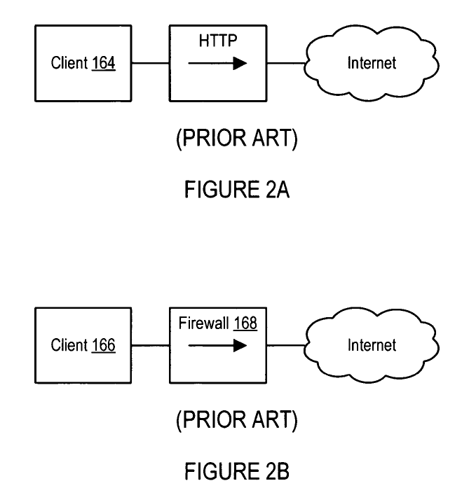

FIG. 2A is a block diagram illustrating the use of the Hypertext Transfer Protocol, as known as HTTP. In HTTP, a client may initiate a transaction by sending a request to a server, which may answer the request with a response. HTTP is a client-initiated protocol. For example, as illustrated in FIG. 2A, HTTP may advantageously be used to carry requests from a client 164 (such as, a web browser) to a server (such as, a web server—not pictured) and to transport pages from the server back to the requesting client.

FIG. 2B is a block diagram illustrating the use of a firewall 168. Generally, a firewall is a security system intended to protect a network from external threats (such as, hackers) coming from another network (such as, the Internet). A firewall typically includes hardware and/or software designed to determine whether a particular message or file from an external source may pass through the firewall to a client (such as, the client 166) and/or to determine whether a client may send a particular message or file through the firewall to an external destination. Firewalls are often configured to limit the protocols through which incoming messages and/or incoming files may arrive and often configured to limit the protocols through which outgoing messages and/or outgoing files may leave.

Many firewalls are configured to deny some or all incoming requests sent via some or all types of protocols. In a typical home use, a person may have an Internet gateway (or other firewall) that allows outgoing HTTP requests from a web browser, allows incoming responses to those outgoing HTTP requests, but denies incoming HTTP requests from external sources. Accordingly, while the person's personal computer is connected to the Internet, the person may use a web browser to access websites to receive content, but need not worry about a would-be intruder requesting and receiving content from the person's personal computer.

Because many clients are configured to use client-initiated protocols and because many clients communicate through firewalls, establishing communication between clients can be often time-consuming and sometimes impossible.

Communication Among Clients

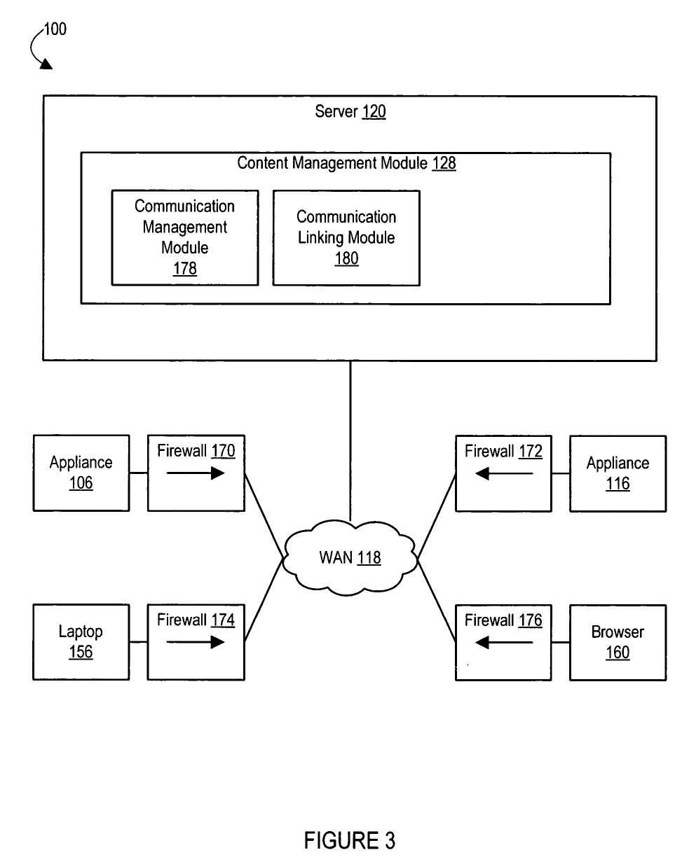

FIG. 3 is an exemplary embodiment of the networking system 100 in which clients may advantageously communicate using embodiments of the invention.

In one embodiment, clients may communicate through an associated firewall, gateway, or the like. For example, the appliance 106 may communicate through a firewall 170, the appliance 116 may communicate through a firewall 172, a laptop 156 may communicate through the firewall 174, and a web browser 160 may communicate through the firewall 176.

In one embodiment, an appliance (such as, the appliance 116) may optionally include a firewall. For example, certain embodiments may include any suitable system or method including, but not limited to, the systems and methods or the like.

In one embodiment, at least one, some, or all of the clients may communicate using HTTP, hypertext transfer protocol secure (“HTTPS”), secure sockets layer (“SSL”), a client-initiated protocol, or any other suitable protocol. In one embodiment, at least one, some, or all of the firewalls 170, 172, 174, and 176 may be configured to deny at least one, some, or all externally-initiated transactions, requests, and the like. Of course, if desired, a firewall (such as, the firewalls 170, 172, 174, and 176) could be configured to allow or to deny any type of transactions, requests, and the like. Also, a client need not communicate through a firewall and, thus, firewalls (such as, the firewalls 170, 172, 174, and 176) are optional.

As shown in FIG. 3, the content management module 128 of the server 120 may comprise a communication management module 178, a communication linking module 180, or both. The communication management module 178 may be configured to receive one or more requests from a client using a suitable protocol. Similarly, the communication linking module 180 may be configured to receive one or more requests from a client. It will be appreciated that some or all of the functions and components of the content management module 128 may be performed among a plurality of servers. Thus, for example, the communication management module 178 could be implemented on a first server and the communication linking module 180 could be implemented on a second server. Of course, the functions and components of the content management module 128 could be implemented in any other suitable configuration.

Embodiments of the invention enable clients to communicate with each other and the methods described herein can be performed, for example, a networking environment, by a content management system, a communication management module, or other modules or suitable system, or any combination thereof.

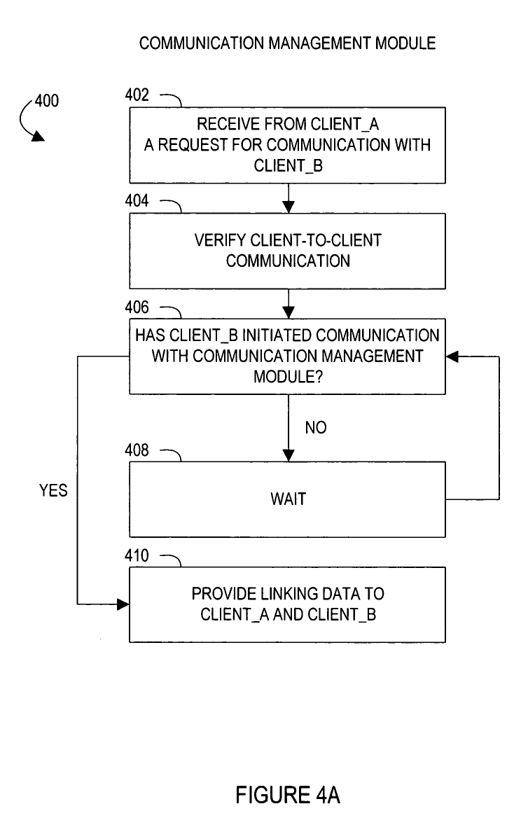

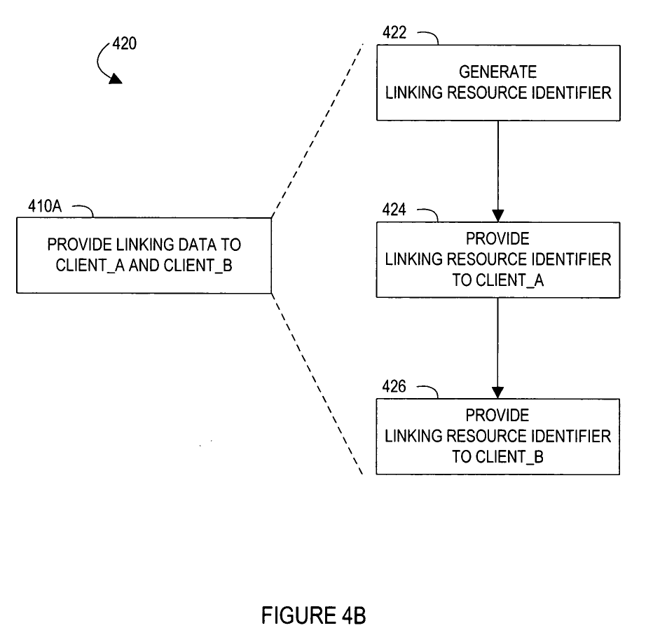

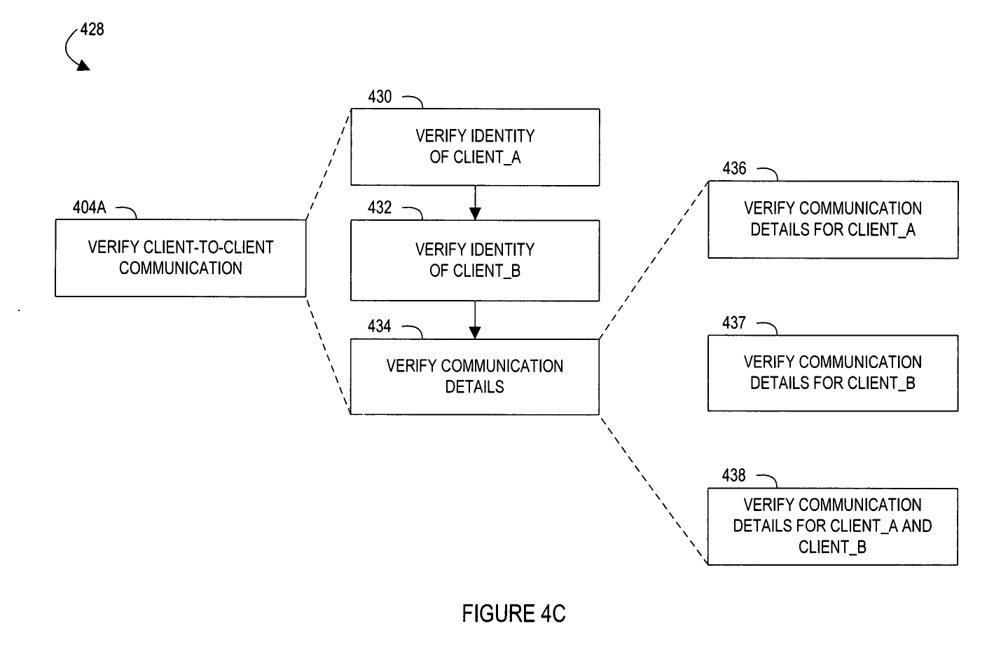

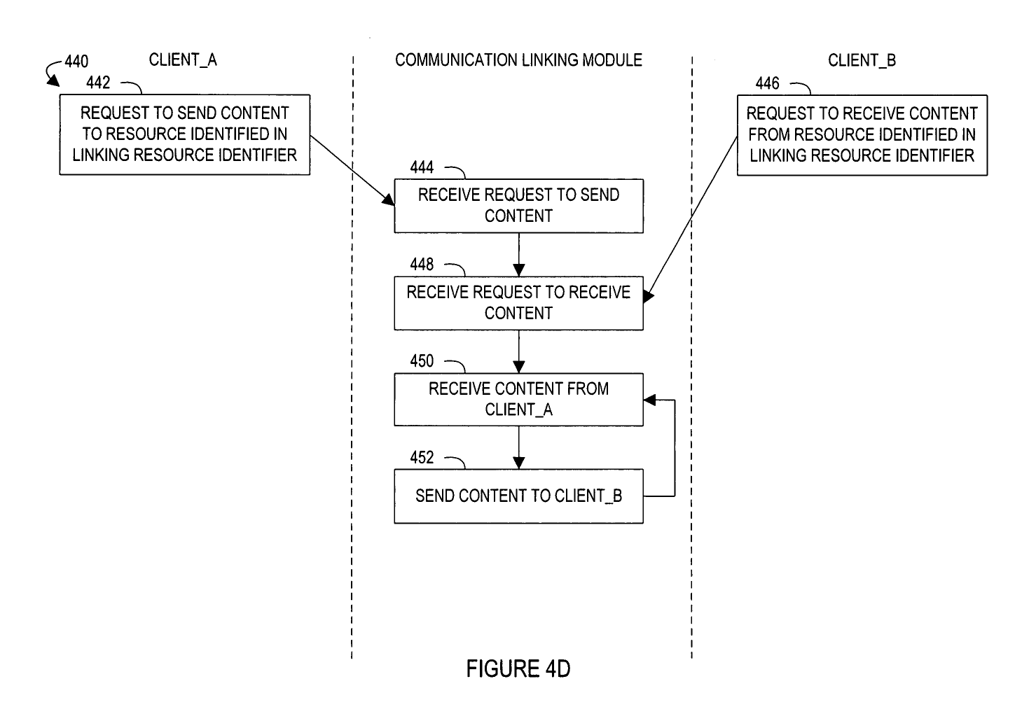

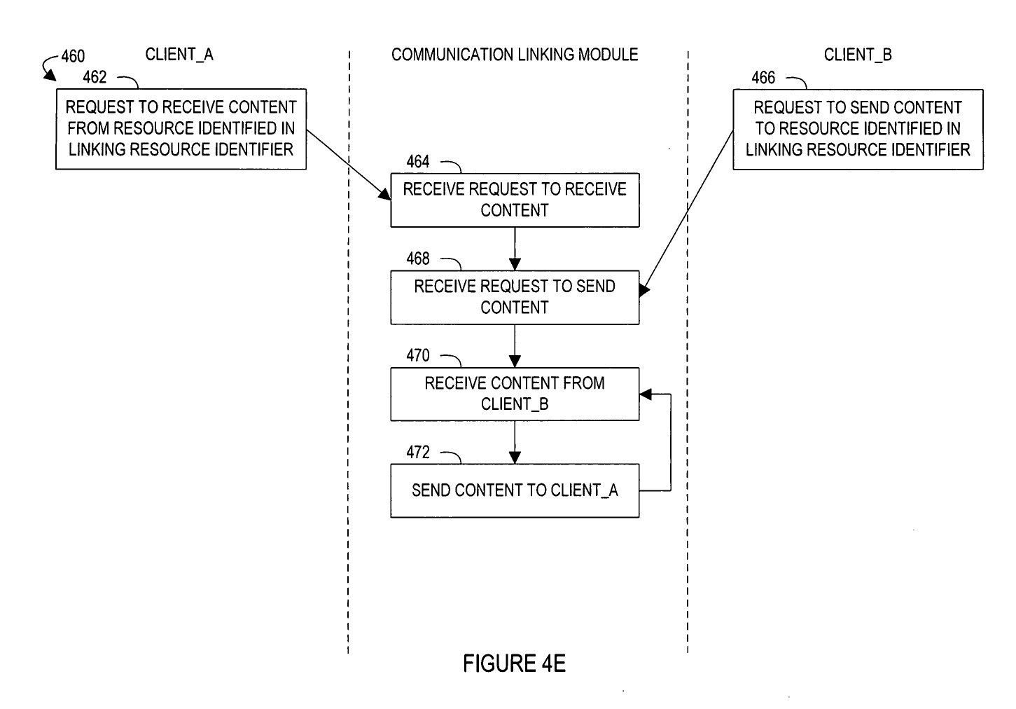

FIG. 4A is a flowchart illustrating an exemplary method 400 for enabling client communication. In one embodiment and with reference to FIG. 3, a first client (“client_a”) may initiate communication with the communication management module 178 to request communication with a second client (“client_b”). At a block 402, the communication management module 178 may receive from client_a a request to communicate with the client_b. The requested communication may have a content-related purpose (such as, content distribution, content synchronization, or the like). For example, the requested communication may comprise sending and/or receiving content. Of course, the requested communication could have any other suitable purpose, including those unrelated to content distribution and/or synchronization.

At a block 404, the communication management module 178 may optionally verify that the requested communication between client_a and client_b should occur before proceeding to a block 406. At a block 406, the communication management module 178 may determine whether the client_b has initiated communication with the communication management module 178. If the client_b has not initiated communication with the communication management module 178, the communication management module 178 may optionally wait an amount of time at a block 408 and then return to the block 406. If, at the block 406, the client_b has initiated communication with the communication management module 178, the communication management module 178 may proceed to the block 410 and provide linking data to the client_a and the client_b. Client_a and client_b use the linking data to communicate with each other.

For example, one or more clients (such as, the appliance 106, the appliance 116, the laptop 156, the browser 160, a content management module of an appliance or a computing device, and the like) may be configured to initiate communication with a communication management module (such as, the communication management module 178) periodically, aperiodically, in response to user input, or according to any other suitable schedule. When client_b initiates communication with a communication management module, the communication management module may determine if any other client has requested communication with the client_b. If another client has requested communication with client_b, the communication management module may provide linking data to the client_b and the other client. Using the linking data, the client_b and the other client may access or use a communication linking module to establish communication. Of course, the client_b and the other client may use the linking data in any other suitable fashion to establish communication.

FIG. 4B is a flowchart illustrating an exemplary method 420 for providing linking data to clients. In one embodiment, the block 410 (FIG. 4A) may comprise a block 410A (FIG. 4B) in which the communication management module 178 may provide linking data to client(s), such as client_a and client_b.

The block 410A may comprise one or more blocks. At a block 422, the communication management module 178 may optionally generate a resource identifier. As used herein, “resource identifier” is a broad term and is used in its ordinary meaning and includes, but is not limited to, a uniform resource locator (“URL”), a relative uniform resource locator (“relative URL” or “RELURL”), a uniform resource identifier (“URI”), a uniform resource name (“URN”), a character string used to identify a resource by location and/or type, a bit string used to identify a resource by location and/or type, data used to identify a resource by location and/or type, an address for a resource on the Internet, an address for a resource on a network, an address in memory, an Internet protocol address (“IP address”), a domain name, a relative address, a path, a relative path, and the like. In one embodiment, the communication management module 178 may generate a linking resource identifier that identifies a resource configured to help link two or more clients. Of course, the communication management module 178 need not generate a resource identifier and could obtain a resource identifier in any other suitable fashion.

When linking one client with another the resource identifier can be used to insure that a server delivers the data provided by one client to the requesting client. In one embodiment, the resource identifier is limited and only used for a particular session. When one client contacts a server requesting data from another client, the resource identifier is used to link the clients such that the content is handled properly as it is delivered from one client to the server and from the server to the other client.

As shown in FIG. 4B, the communication management module 178 may provide a resource identifier (such as, a linking resource identifier) to the client_a at a block 424 and the client_b at a block 426. Also, it will be appreciated that, at the block 422, the communication management module 178 may obtain a plurality of resource identifiers which could be the same or different. Indeed, the resource identifiers could differ in any respect, depending, for example, upon the intended function of the resource identifiers. Accordingly, if desired, the communication management module 178 could provide one resource identifier to the client_a the block 424 and a different (or the same) resource identifier the client_b at the 426.

FIG. 4C is a flowchart illustrating an exemplary method 428 for verifying client to client communication. In one embodiment, the block 404 (FIG. 4A) may comprise a block 404A (FIG. 4C) in which communication among two or more clients may be verified. The block 404A may comprise one or more blocks. At blocks 430 and 432, the identity client(s) (such as, the client_a and the client_b) may be verified using any suitable method or system.

At the block 434, which may comprise one or more blocks, any suitable detail about the requested communication may be verified. In one embodiment, the content management module 128 (or any suitable component thereof, such as, the communication management module 178) may verify communication details for the client_a at a block 436, verify communication details for the client_b at a block 437, may verify communication details for the client_a and the client_b at the block 438, or any suitable combination thereof.

For example, the content management module 128 may implement one or more identity-based, content-management rules. Accordingly, the contact management rules could define appropriate content-related activities (such as, distribution, synchronization, or the like) in which client_a may participate, in which client_b may participate, and in which client_a and client_b may participate together. The content management rules could identify one or more content-related actions to be performed in response to one or more events, in response to metadata associated with content, in response to other suitable factors, or any suitable combination thereof.

In one embodiment, at the block 434, the content management module 128 (or any suitable component thereof, such as, the communication management module 178) may verify details about the requested communication by using any request-related procedures, any permission-related procedures, or any other system or procedure of the like.

Of course, the content management module 128 may verify the requested communication using any other suitable features, functions, and/or systems. In some embodiments, however, the content management module 128 need not verify any aspect of the requested communication, and, thus, the block 404 (FIG. 4A) is optional.

FIG. 4D is a flowchart illustrating an exemplary method 440 for linking clients. In FIG. 4D, the communication that the client_a requested may include sending content to the client_b. Accordingly, the client_a may send a request to send content to a resource identified in a resource identifier to a server. At a block 444, the communication linking module 180 of the server may receive the request to send content from the client_a.

At a block 446, the client_b may send a request to receive content from a resource identified in a resource identifier. At a block 448, the communication linking module of the server may receive the request to receive content. Of course, the client_b may provide (and the server may receive) the request in any suitable manner and using any suitable protocol and/or system.

In one embodiment, after receiving a “sending” client's request to send content and after receiving a “receiving” client's request to receive content, the communication linking module 180 may facilitate the transfer of the content from the “sending” client to the “receiving” client by (in response to the “sending” client's request) receiving the content from the “sending” client and by (in response to receiving the “receiving” client's request) sending the content to the “receiving” client.

In one embodiment, to facilitate the transfer of the content among clients, the communication linking module 180 may include at least one data structure that may associate a resource identifier (or a portion of a resource identifier) with at least one client that has requested to receive content, with at least one client that has requested to send content, or both. For example, when the communication linking module 180 receives a “sending” client's request to send content to a resource identifier, the communication linking module 180 may update the data structure to indicate that the “sending” client has requested to send content to the resource identifier. Also, when the communication linking module 180 receives a “receiving” client's request to receive content from the resource identifier, the communication linking module 180 may update the data structure to indicate that the “receiving” client has requested to receive content from the resource identifier. Accordingly, the communication linking module 180 may access the data structure to determine whether a resource identifier (or a portion of a resource identifier) is associated with both a “sending” client and a “receiving” client. If desired, the communication linking module 180 could compare all or a portion of a resource identifier (associated with a first client) with all or a portion of a resource identifier (associated with a second client) to determine whether a resource identifier is associated with both a “sending” client and a “receiving” client.

If the communication linking module 180 determines that a resource identifier (or a portion of a resource identifier) is associated with both a “sending” client and a “receiving” client, the communication linking module 180 may receive the content from the “sending” client and send that content to the “receiving” client. If desired, the communication linking module 180 could be configured to store the content received from the “sending” client at the particular location identified in the resource identifier, which then could be accessed by the “receiving” client. However, rather than storing the content at the particular location identified in the resource identifier, the communication linking module 180 could temporarily buffer the content until sending the content to the “receiving content,” as described below.

FIG. 4E is a flowchart illustrating an exemplary method 460 for linking clients. In FIG. 4E, the communication that the client_a requested may comprise receiving content from the client_b, whereas client_a requested sending content to client_b in FIG. 4D. Accordingly, at a block 462, the client_a may send a request to receive content from a resource identified in a resource identifier. At a block 464, the communication linking module 180 may receive the request to receive content. At a block 466, the client_b may send a request to the server to send content to a resource identified in a resource identifier. At a block 468, the communication linking module 180 may receive the request to send content.

At a block 470, the communication linking module 180 may receive at least one portion of a copy of content from the client_b. The communication linking module 180 may optionally store the received content in a buffer and, at a block 472, may send the received content to the client_a periodically, aperiodically, after the received portion of content reaches a particular size, after the entire content has been received, or according to any other suitable schedule. As shown, in one embodiment, the communication linking module 180 may repeatedly receive one or more portions of content at the block 470 and send those one or more portions at the block 472 until some or all of the content has been received and sent.

As shown in FIGS. 4D and 4E, the communication linking module 180 may send and receive content in a generally simultaneous manner, in a multi-tasked manner, or in any other suitable manner. In some embodiments, a client (such as, client_a or client_b) may request to send content to a server, to another client, or to any module thereof using the “PUT” HTTP command, the “POST” HTTP command, or any other suitable command or protocol. Similarly, in some embodiments, a client may request to receive content from a server, from a client, or from any module thereof using the “GET” HTTP command or any other suitable command or protocol. Thus, for example, by receiving (and responding to) HTTP commands (such as, “PUT,” “POST,” “GET,” and the like), the communication linking module 180 may send and receive content in a manner generally transparent to the requesting clients client_a and client_b. Of course, the communication linking module 180 need not receive or send content via HTTP or any HTTP commands. Indeed, any of a variety of other protocols could be used to send and receive content transparently, non-transparently, or in any other suitable manner.

As shown in FIGS. 4A-4E, client(s), such as, the client_a and the client_b, may communicate for any suitable purpose (distribute content, synchronize content, etc.). Of course, the client_a and the client_b may comprise any suitable client (such as, a computing device, an appliance, a content management module, a web browser, and the like) and need not comprise the same or similar types of clients. Further, the client_a and client_b may communicate for any other suitable purposes, including those unrelated to content management, content distribution, and content synchronization.

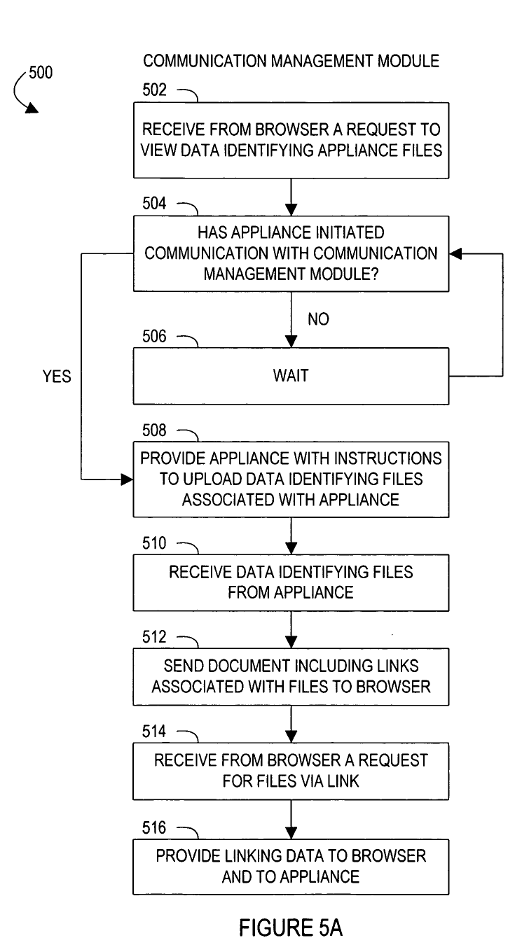

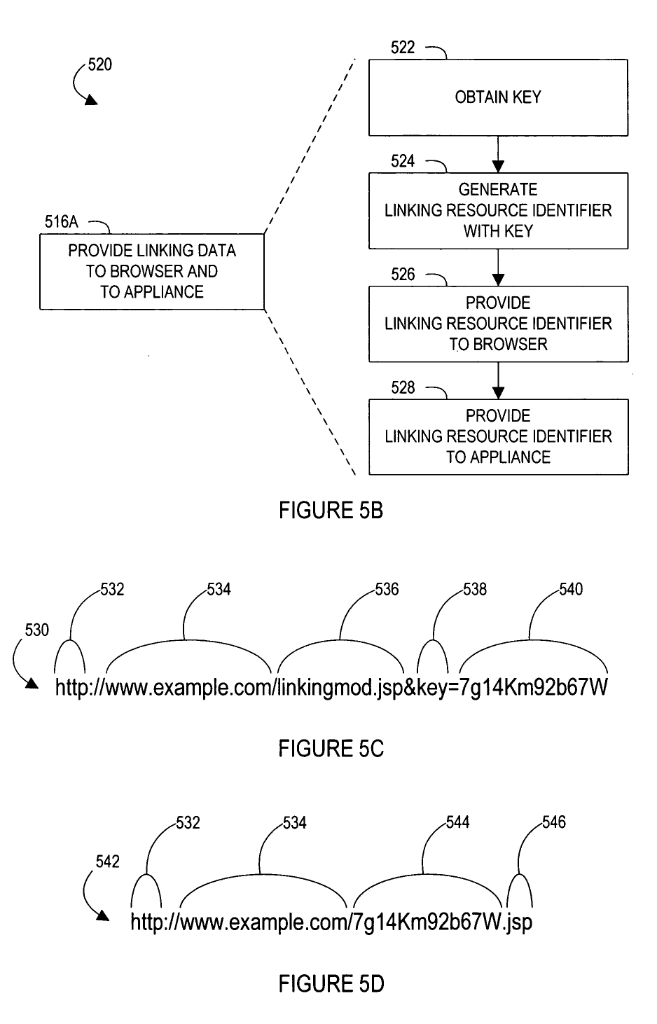

FIG. 5A is a flowchart illustrating an exemplary method 500 for linking one client with another client. At a block 502, the communication management module 178 may receive from a client (such as, the browser 160) a request to view a list (or other formatted or unformatted display) of content (such as, one or more data files) stored on at least one storage device associated with an appliance. For example, a user may use the browser 160 to select a hyperlink configured to identify at least one an appliance. In response to the user's selection of the hyperlink, the browser 160 may send (to the server 120 or a component thereof) a request configured to identify at least one an appliance.

At a block 504, the communication management module 178 may determine whether the source appliance identified by the request has initiated communication with the communication management module 178 of the server. If the source appliance has not initiated communication with the communication management module 178, the communication management module 178 may optionally wait an amount of time at a block 506 and then return to the block 504. If, at the block 504, the source appliance has initiated communication with the communication management module 178, the communication management module 178 may, at a block 508, provide the source appliance with instructions to upload data identifying files stored in the storage device associated with the source appliance. In response to receiving the instructions to upload data, the source appliance may send (to the server 120 or a component thereof) data identifying one or more files stored on one or more associated data storage devices, which data the communication management module 178 may receive at a block 510.

At a block 512, the communication management module 178 may use the received data to generate and/or send a document (such as, a hypertext document, an HTML document, or the like) that includes hyperlinks configured to identify at set of one or more files on a data storage device associated with the source appliance. The browser 160 may receive and display the received document. A user may use the browser 160 to select (from the received document) a hyperlink configured to identify a set of one or more files stored on a data storage device associated with the source appliance. In response to the user's selection of the hyperlink, the browser 160 may send a request configured to identify the selected set of one or more files, which request the communication management module 178 may receive at a block 514.

At a block 516, in response to receiving the request configured to identify the selected set of one or more files, the communication management module 178 may advantageously provide linking data to the source appliance and the browser 160, which the source appliance and the browser 160 may use to help send the selected set of one or more files from the source appliance to the browser 160.

FIG. 5B is a flowchart illustrating an exemplary method 520 for providing linking data, in this example, to a browser and an appliance. One of skill in the art can appreciate that the clients may both be appliances or other computing devices as previously described. In one embodiment, the block 516 (FIG. 5A) may comprise a block 516A (FIG. 5B) in which the communication management module 178 may provide linking data to client(s), such as the browser 160 and the source appliance.

The block 516A may comprise one or more blocks. At a block 522, the communication management module 178 may optionally obtain a key in any suitable fashion. For example, the communication management module 178 could generate a key using a timestamp, a random number, both a timestamp and a random number, or any other suitable key generated in any suitable fashion. At a block 524, the communication management module 178 may generate a resource identifier (such as, a linking resource identifier), which may optionally be generated using the key obtained the block 522.

At a block 526, the communication management module 178 may provide the resource identifier to the browser 160 and, at a block 528, to the source appliance. The browser 160 may use the resource identifier to request to receive content from the resource identified in the resource identifier, as shown in the block 462 of the FIG. 4E. In one embodiment, at the block 528, the communication management module 178 may send data identifying or otherwise indicating the selected set of one or more files, which the source appliance may use to retrieve a copy of the selected set or one or more files. The source appliance may use the resource identifier to request to send content to the resource identified in the resource identifier, as shown in the block 466 of the FIG. 4E. Thus, the browser 160, the source appliance, and the communication management module 178 may proceed to send the selected set of one or more files from the source appliance to the browser 160. A user may use the browser 160 to store the selected file or files in an associated storage device.

Also, it will be appreciated that, at the block 524, the communication management module 178 may obtain and/or generate a plurality of resource identifiers which could be the same or different. Indeed, the resource identifiers could differ in any respect, depending, for example, upon the intended function of the resource identifiers. Accordingly, if desired, the communication management module 178 could provide one resource identifier to the browser 160 the block 526 and a different (or the same) resource identifier the source appliance at the block 528.

In one embodiment, at the block 526, the communication management module 178 may optionally provide a resource identifier to the browser 160 by generating a document (such as, an HTML document or the like) that, upon being loaded by the browser 160, causes the browser 160 to send a request to receive content from the resource identified in the resource identifier. Of course, the communication management module 178 may provide a resource identifier to the browser 160 in any other suitable fashion.

FIG. 5C illustrates a resource identifier 530 according to an exemplary embodiment of the invention. The resource identifier 530 may comprise a character string, a bit string, or the like—which may indicate or comprise some or all of a protocol 532, a hostname 534, a filename 536, a parameter name 538, a parameter value 540, or other suitable data. Advantageously, in one embodiment, the resource identifier 530 may comprise the resource identifier generated at the block 524 (FIG. 5B), and the parameter value 540 may comprise the key obtained at the block 522 (FIG. 5B). Thus, for example, upon receiving a request from a first client to receive content from a resource identifier having a particular parameter value 540 and upon receiving a request from a second client to send content to a resource identifier having that particular parameter value 540, the communication management module 178 may advantageously receive the content from the second client and send the content to the first client in any suitable manner, as illustrated in blocks 470 and 472 (FIG. 4E).

FIG. 5D illustrates a resource identifier 542 according to another exemplary embodiment of the invention. The resource identifier 542 may comprise a character string, a bit string, or the like—which may indicate or comprise some or all of a protocol 532, a hostname 534, a filename (which may include a name 544 and an extension 546), or other suitable data. Advantageously, in one embodiment, the resource identifier 542 may comprise the resource identifier generated at the block 524 (FIG. 5B), and the filename (or one or more portions thereof) may comprise the key obtained at the block 522 (FIG. 5B). Thus, for example, upon receiving a request from a first client to receive content from a resource identifier having a particular filename (or portion thereof) and upon receiving a request from a second client to send content to a resource identifier having that filename (or portion thereof), the communication management module 178 may advantageously receive the content from the second client and send the content to the first client in any suitable manner, as illustrated in blocks 470 and 472 (FIG. 4E).

In one embodiment, the communication management module 178 may advantageously compare at least a portion of a first client's request to receive content from a first resource identifier with at least a portion of a second client's request to receive content from a second resource identifier. In that embodiment, if the portion of the first client's request matches the portion of the second client's request, the communication management module 178 may proceed to receive content from the second client and send the content to the first client. The communication management module 178 could compare some or all of the two resource identifiers. The communication management module 178 could compare the filenames (or portions thereof) of each resource identifier. The communication management module 178 may compare one, two, or more parameters of each resource identifier. Of course, the communication management module 178 may send and receive content among clients without comparing any portion of any requests or resource identifiers.

It will be appreciated that a resource identifier may have any other suitable configuration other than the resource identifiers 530 and 542. The resource identifiers 530 and 542 are merely illustrative embodiments of resource identifiers and include various features, none of which are required. Indeed, a resource identifier may include other features not illustrated in FIGS. 5C and 5D.

The methods and systems described above can be implemented using software, hardware, or both hardware and software. For example, the software may advantageously be configured to reside on an addressable storage medium and be configured to execute on one or more processors. Thus, software, hardware, or both may include, by way of example, any suitable module—such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (FPGAs), application-specific integrated circuits (ASICs), controllers, computers, and firmware to implement those methods described above. The functionality provided for in the software, hardware, or both may be combined into fewer components or further separated into additional components. Additionally, the components may advantageously be implemented to execute on one or more computing devices.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The methods and systems described above require no particular component or function. Thus, any described component or function—despite its advantages—is optional. Also, some or all of the described components and functions may be used in connection with any number of other suitable components and functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A communication system for establishing communication among a plurality of clients, the communication system comprising:
a server comprising:
a communication management module;
the communication management module configured to receive, from a first client via a client-initiated protocol, a request indicating a communication between at least the first client and a second client;
the communication management module configured to verify that the communication between at least the first client and the second client is permitted;
the communication management module configured to provide a resource identifier to the first client, in response to a request sent by the first client via the client-initiated protocol, and to the second client, in response to a request sent by the second client via a client-initiated protocol; and
a communication linking module that uses the resource identifier to receive content from the first client and send the content to the second client.

2. The communication system of claim 1, wherein the first client comprises a first appliance comprising a computing device configured to distribute content to at least one computing device and configured to synchronize content to at least one computing device and wherein the second client comprises a second appliance comprising a computing device configured to distribute content to at least one computing device and configured to synchronize content to at least one computing device.

3. The communication system of claim 1, wherein at least one of the first client and the second client comprises a web browser and wherein at least one of the first client and the second client comprises a computing device.

4. The communication system of claim 1, wherein the communication between at least the first client and the second client comprises at least one of content synchronization and content distribution.

5. The communication system of claim 1, wherein the communication linking module is configured to receive the content in response to a request sent via a client-initiated protocol and is configured to send the content in response to a request sent via a client-initiated protocol.

6. The communication system of claim 1, wherein the communication between the first client and the second client comprises at least one of sending content from the first client to the second client and sending content from the second client to the first client.

7. The communication system of claim 1, wherein the communication management module obtains a key and generates the resource identifier using the key.

8. The communication system of claim 1, wherein the communication management module obtains a key and generates the resource identifier using the key and wherein at least a portion of the resource identifier comprises the key.

9. The communication system of claim 1, wherein the first client is behind a first firewall and the second client is behind a second firewall.

10. A method for facilitating communication among a plurality of clients, the method comprising:
receiving, from a first client, a request to view data identifying one or more files associated with a second client;
receiving, from the second client, the data identifying the one or more files;
sending, to the first client, a document including one or more links including one or more requests associated with the one or more files;
receiving, from the first client, at least one of the one or more requests associated with the one or more files; and
providing linking data to the first client and the second client, wherein the linking data comprises a resource identifier.

11. The method of claim 10, further comprising determining whether a connection initiated by the second client is open.

12. The method of claim 10, further comprising:
determining whether a connection initiated by the second client is open;
if a connection initiated by the second client is not open, waiting a period of time; and
determining whether the connection initiated by the second client is open after the period of time expires.

13. The method of claim 10, further comprising:
determining whether a connection initiated by the second client is open; and
sending, to the second client, a response identifying the one or more files;

14. The method of claim 10, wherein the first client comprises a web browser and wherein the second client comprises an appliance having a computing device configured to distribute content to at least one computing device and configured to synchronize content to at least one computing device.

15. A method for establishing communication among a plurality of computing devices, the method comprising:
sending, to a server, a request;
receiving, from the server, a response to the request, the response indicating a request from a first computing device to view first data identifying at set of one or more files stored on a storage device associated with a second computing device;
sending, to the server, the first data identifying the set of one or more files;
receiving, from the server, linking data comprising a resource identifier and second data identifying at least one of the files in the set of one or more files;
retrieving a copy of the at least one of the files in the set of one or more files;
sending the copy of the at least one of the files in the set of one or more files to the location identified by the resource identifier;
wherein the resource identifier is associated with a communication linking module configured to receive first content from the second computing device and configured to send the first content to the first computing device.

16. The method of claim 15, wherein the first computing device comprises a first appliance configured to distribute content to at least one computing device and configured to synchronize content to at least one computing device and wherein the second computing device comprises a second appliance configured to distribute content to at least one computing device and configured to synchronize content to at least one computing device.

17. The method of claim 15, wherein the first computing device comprises a web browser.

18. The method of claim 15, wherein the second computing device is behind a firewall.

19. The method of claim 15, wherein the second computing device is configured to send data to server and receive data from the server via a client-initiated protocol.

20. A communication system comprising
a server including:
a first computing device; and
means for providing linking data;
a second computing device comprising:
first means for receiving the linking data; and
a third computing device comprising:
second means for receiving the linking data;
wherein the second computing device is configured to distribute first content to at least one computing device and to synchronize the first content and wherein the third computing device is configured to distribute second content to at least one computing device and configured to synchronize the second content.

21. The communication system of claim 21, wherein further comprises:
means for receiving third content from at least one of the second computing device and the third computing device and for sending the third content to at least one of the second computing device and the third computing device.

22. A method for linking a first client with a second client to enable the first client to communicate with the second client, the method comprising:
receiving a request at a server from a first client to communicate with a second client;
receiving a communication from the second client;
providing the first client and the second client with linking data including a resource identifier; and
communicating content between the first client and the second client using the resource identifier.

23. The method of claim 22, further comprising generating the linking data.

24. The method of claim 22, further comprising:
verifying identify of the first client and of the second client; and
verifying communication details between the first client and the second client.

25. The method of claim 22, further comprising sending content from the second client to the first client by at least one of:
sending the content as the content is received;
storing the content in a buffer and sending the content when the buffer is at a certain size; and
sending the content only after all the content is received.

26. The method of claim 22, identifying content communicated between the first client and the second client by the resource identifier.

27. The method of claim 22, further comprising providing a first resource identifier to the first client and a different resource identifier to the second client.

28. The method of claim 22, wherein communicating content between the first client and the second client using the resource identifier comprises:
receiving a client-initiated request to send content to a first resource identifier;
storing first data indicating the client-initiated request to send content to the first resource identifier;
receiving a client-initiated request to receive content from a second resource identifier;
comparing at least a portion of the first resource identifier and at least a portion of the second resource identifier;
in response, at least in part, to the comparison, receiving content in responding to the client-initiated request to send content; and
in response, at least in part, to the comparison, sending content in responding the client-initiated request to receive content.

29. The method of claim 22, wherein communicating content between the first client and the second client using the resource identifier comprises:
receiving a client-initiated request to receive content from a first resource identifier;
storing first data indicating the client-initiated request to receive content from a first resource identifier;
receiving a client-initiated request to second content to a second resource identifier;
comparing at least a portion of the first resource identifier and at least a portion of the second resource identifier;
in response, at least in part, to the comparison, receiving content in responding to the client-initiated request to send content; and
in response, at least in part, to the comparison, sending content in responding the client-initiated request to receive content.
